(19) United States
(12) Patent Application Publication
(10) Pub. No.: US 2012/0314044 A1
(43) Pub. Date: Dec. 13, 2012

(54) IMAGING DEVICE

(76) Inventor: Satoru Ogawa, Kanagawa (JP)

(21) Appl. No.: 13/494,053

(22) Filed: Jun. 12, 2012

(30) Foreign Application Priority Data
Jun. 13, 2011 (JP) 2011-130846

(51) Int. Cl. G06K 9/48; H04N 7/18

(52) U.S. Cl. 348/77; 348/E07.085

(57) ABSTRACT

A digital signal circuit 18 detects a human body from an image signal obtained by photographing, and detects a face portion. A system control circuit 20 estimates an age of the human body from a proportion of a head portion to a shoulder potion of the human body, determines that the object is an infant if the estimated age is equal to or lower than a threshold age, and automatically flashes an LED 30 to attract the attention of the object.

### PRIORITY INFORMATION

This application claims priority to Japanese Patent Application No. 2011-130846 filed on Jun. 13, 2011, which is incorporated herein by reference in its entirety.

### BACKGROUND OF THE INVENTION

1. Field of the Invention

The present invention relates to an imaging device, and particularly to age estimation of an object person.

2. Description of the Related Art

Techniques of detecting a human body as an object from a photographed image have been proposed.

For example, JP 2005-149145 A discloses a substance detection device having a template controlling section for storing a template of a closed curve indicating a part of a contour of a human body model or a human body part, an image data receiving section for inputting an image of an object to be detected, and a head position detecting section for performing matching of the input image with a plurality of templates, thereby detecting a human body from the image.

In addition, JP 2003-132340 A discloses a method of determining a shape of a person with a contour extraction means for extracting contour data of an object to be determined in a two-dimensional image, a shape value generation means for calculating a ratio between a straight-line portion and a curve portion of a contour from the extracted contour data, and a determination means for determining if the object is a person by comparing a predetermined threshold with the ratio between the straight-line element and the curve element of the contour data calculated by the shape value generation means.

Further, JP 2010-117772 A discloses a device having an edge image extraction section for forming an edge image from an image, and further discloses calculating, as an amount of characteristic of an image, the number of edge pixels defined by the spatial position relation between an edge direction of a predetermined pixel and edge directions of edge pixels existing in a neighboring area of the predetermined pixel, and the predetermined pixel and the edge pixels existing in the neighboring area, thereby improving the identification accuracy of a person image.

Furthermore, JP 2007-248698 A discloses storing the standard size of a face and computing the actual distance to an object's face based on this size and the size of a photographed face.

JP 2002-298142 A discloses a technique of determining whether or not an object is a person based on the ratio between the sizes of the head portion and the body portion.

JP 2001-257911 A, JP 2005-164623 A, and JP 2009-290511 A disclose photographing an image of an infant, while displaying an image which attracts an infant's attention.

If an image obtained by an imaging device such as a digital camera includes a person as an object, it is possible to detect the person or the human being included in the image by the above-descried various methods. However, there has not been sufficient consideration of how to utilize the detected information if a person or a human being is detected.

For example, JP 2005-149145 A merely discloses using a technique of detecting a human body from an image for the purpose of security management in facilities, and nowhere describes positively utilizing the technique when a digital camera performs imaging control.

### SUMMARY OF THE INVENTION

The object of the present invention is to provide a device which can detect a human body included in a photographed image, estimate an age of a person as an object using the detection result, and appropriately photograph an image of the object based on the estimated age.

The present invention is an imaging device having an optical system which includes a lens, an imaging section which converts an object image formed by the optical system to an electrical signal, and a controlling section which estimates an age of an object based on at least one of a human body detected using an edge pattern of an image signal obtained by the imaging section and a face portion detected from the image signal obtained by the imaging section, determines whether or not the object is an infant from the estimated age, and if the object is determined to be an infant, automatically outputs visual or auditory information to the object.

In an embodiment according to the present invention, the control section estimates an age using a ratio between the length of the head portion and the length of the shoulder portion of the human body.

In another embodiment of the present invention, the control section estimates an age from both of the human body and the face portion, and if both estimated ages match within a predetermined acceptable range, determines whether or not the object is an infant using the estimated ages.

In still another embodiment of the present invention, the control section changes a form of an output between the visual information and the auditory information according to the accuracy of the estimated age.

With the present invention, it is possible to automatically estimate an age of an object and automatically set photographing conditions according to the estimated age. In particular, if the object is determined to be an infant from the estimated age, information for drawing the infant's attention is output, thereby easily obtaining an image which is photographed when the infant's gaze is drawn.

### BRIEF DESCRIPTION OF THE DRAWINGS

FIG. 1 shows a configuration diagram of a digital camera according to an embodiment of the present invention;

FIG. 2 shows a processing flowchart according to an embodiment;

FIG. 3 shows another processing flowchart according to an embodiment;

FIG. 4 shows still another processing flowchart according to an embodiment;

FIG. 5 shows a flowchart of processing of human body detection according to an embodiment;

FIG. 6 shows a schematic diagram of human body detection; and

FIG. 7 shows an external perspective view of a digital camera according to an embodiment.

### DESCRIPTION OF THE PREFERRED EMBODIMENTS

Embodiments of the present invention will be described hereinafter with reference to the drawings. The following embodiments are merely examples and the present invention is not limited to the following embodiments.

First, a basic configuration of a digital camera as an imaging device according to the present embodiment will be described.

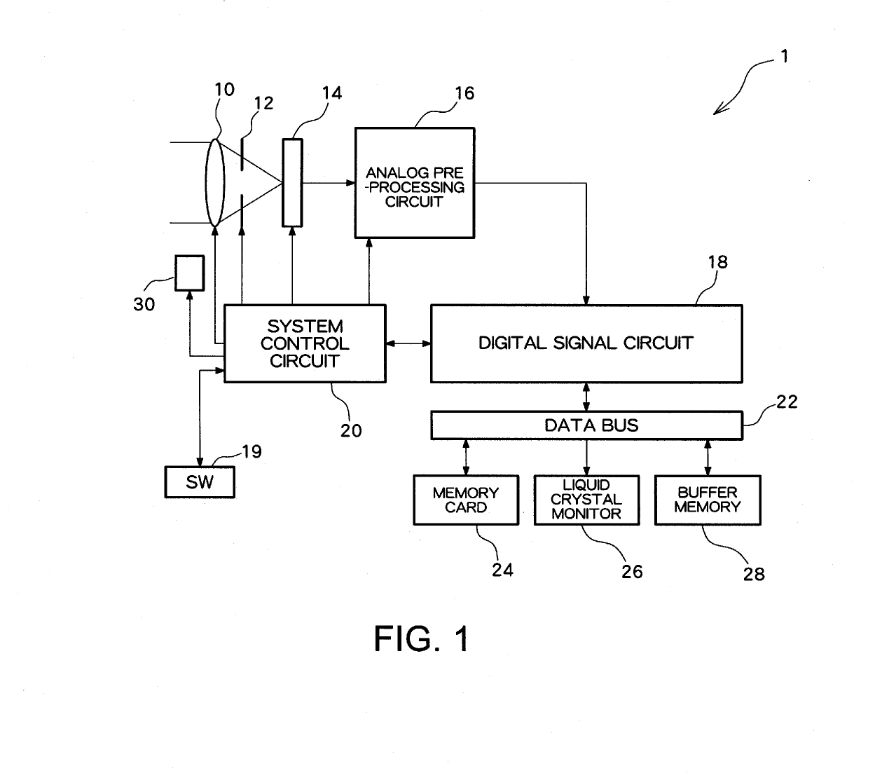

FIG. 1 shows a configuration block diagram of a digital camera according to the present embodiment. An object image is formed on an imaging element 14 via a lens 10 and a shutter and aperture 12. The imaging element 14 converts the object image to an electrical signal and outputs the result, as analog image signals, to an analog preprocessing circuit (analog front end) 16. The aperture is driven and controlled by an exposure control signal from a system control circuit 20 (auto exposure control, that is, AE). In addition, the lens 10 is driven and controlled by a focus control signal from the system control circuit 20 (auto focus control, that is, AF).

The imaging element 14 is provided with optical filters, such as an IR cut filter, optical low-pass filter, and color filter array. A CCD imaging element or a CMOS imaging element is employed as the imaging element 14.

The analog preprocessing circuit (analog front end) 16 has an analog amplifier, a gain controller, and an AD converter, amplifies an analog image signal from the imaging element 14, converts the result to a digital image signal, and outputs the result to a digital signal processing circuit 18.

The digital signal processing circuit 18 performs, on the supplied digital image signal, white balance adjustment, gamma compensation, synchronization processing, RGB-YC conversion, noise reduction processing, contour correction, and JPEG compression.

White balance adjustment is processing for correcting the balance of RGB based on a light source color temperature, and adjusting gains of an R signal, G signal, and B signal which are input. Gain adjustment methods includes a method of manually inputting, for example, a type of a light source (sunlight or lamp light) by the user and adjusting a gain based on the input light source, a method of locating white and gray objects under an imaging light source, photographing the objects by a camera, and correcting the photographed image, and a method of automatically identifying a light source by a camera and compensating a gain (auto white balance adjustment).

Gamma compensation is processing for adjusting output characteristics of the imaging element 14 to predetermined gradation characteristics.

Synchronization processing is processing for calculating a signal of a missing color by computing color signals of the neighboring pixels. This is necessary because, in a single-chip method where a Bayer pattern color filter is adopted, a pixel has only a signal of one color. Methods of synchronization processing include, for example, a method of averaging values of neighboring pixels and a method of calculating weighted average of neighboring pixels according to a distance from a target pixel.

RGB-YC conversion processing is processing for converting the synchronized R signal, G signal, and B signal to a Y signal, Cb signal, and Cr signal, respectively. That is, they are converted to the Y signal as a luminance signal, and the Cb signal and the Cr signal as color-difference signals, respectively, according to the following expressions.

Y=0.30R+0.59G+0.11B

Cb=B−Y

Cr=R−Y

Noise reduction processing is processing for removing isolated points such as pulse noise using a median filter, etc. This processing is usually performed on the color-difference signals Cb and Cr because, although this processing removes noise, it also affects the resolution.

Contour correction processing is processing for correcting degradation of a modulation transfer function due to the effect of the optical low-pass filter and so on, and in this processing, a contour signal is added to an original image signal through contour extraction processing and non-linear processing. The contour correction processing is usually performed on the luminance signal.

JPEG compression is performed by dividing each of the Y signal serving as the luminance signal and the Cb and Cr signals serving as the color-difference signals into blocks of eight by eight pixels, and performing DCT conversion, quantization, and Huffman coding on each block in series.

The digital signal processing circuit 18 stores the compressed image signal, on which the above-described processing is performed, in a buffer memory 28 via a data bus 22, and reads the image data stored in the buffer memory 28 to thereby display it on a liquid crystal monitor 26. The digital signal processing circuit 18 may also store the image signal in a memory card 24.

The system control circuit 20 controls the operation of each component based on signals input from switches (SW) 19. For example, the system control circuit 20 controls the operation of each component based on an operation signal from a shutter button 19a, and displays the photographed image on the liquid crystal monitor 26 or stores it in the memory card 24. In addition, upon photographing an image, the system control circuit 20 performs auto exposure control (AE) and auto focus control (AF) as described above. As for focus control, there are contrast detection AF and TTL phase difference detection AF. As for contrast detection AF, a focusing position is defined as a point in which the contrast of a photographed image is highest. When the focus is moved slightly from its current position and the contrast becomes lower, the focus is then moved in the opposite direction, while when the contrast becomes higher, the focus continues to be moved in the same direction, and when the contrast becomes lower in both directions, that position is recognized as a focusing position (the so-called “hill-climbing” method). As for TTL phase difference detection AF, a focusing unit measures lens-transmitted light and determines a focusing position of a lens. The focusing unit determines the focusing position using a feature that an image moves side to side according to a direction and an amount of a gap from the focusing position.

In such a configuration, the digital signal processing circuit 18 performs each of the above-described processing, while performing the human body detection processing to detect whether or not a human body is included in the obtained image signal and outputting the detection result to the system control circuit 20.

The digital signal processing circuit 18 also detects whether or not the obtained image signal includes a face (FD). Face detection is performed using a face contour and relative positions and sizes of facial parts (such as eyes, nose, and mouth). A face may also be detected using color data (whether or not a color of skin is included). Face AF for detecting a face and controlling a focus to be on the face, face AE for detecting a face and controlling exposure, and face WB for detecting a face and adjusting the white balance are known. Face detection algorisms used in these face AF, face AE, and face WB can be directly applied to the present invention.

The system control circuit 20 estimates the age of an object person using the human body detection information from the digital signal processing circuit 18. Specifically, the system control circuit 20 estimates the age of the object person using the size of the human body included in the human body detection information.

It is known that the size of an image of each part of the human body changes with age. For example, the ratio of the head portion with respect to the entire body changes with age. The ratio between the sizes of the head portion and the shoulder portion also changes with age. The system control circuit 20 stores, in the memory, the relationship between the age and the size of the human body or the ratio of the human body parts in a form of a table in advance, and refers to this table to thereby estimate the age of the object person. The system control circuit 20 then sets photographing conditions based on the estimated age. Specifically, the system control circuit 20 determines whether or not the estimated age is less than or equal to a threshold age, and if the estimated age is less than or equal to the threshold age, recognizes the object as an infant and sets photographing conditions that are considered to be preferable for photographing an infant. If the object is an infant, it is rare for them to keep looking at a digital camera for a certain length of time because an infant is interested in everything in the surrounding environment. As such, it is well known that it is relatively difficult to photograph a front image of an infant. Thus, if the system control circuit 20 recognizes the object to be an infant, the system control circuit 20 performs control so as to draw the infant's attention to the digital camera by visual or auditory stimulation.

The size of the human body is, more specifically, the size of the upper half of the human body, and the size of the upper body includes, for example, the size of the head portion (the length of the head portion and the width of the head portion) and the size of the shoulder portion (the width of the shoulders). The size is defined as the number of pixels constituting the head portion or the shoulder portion.

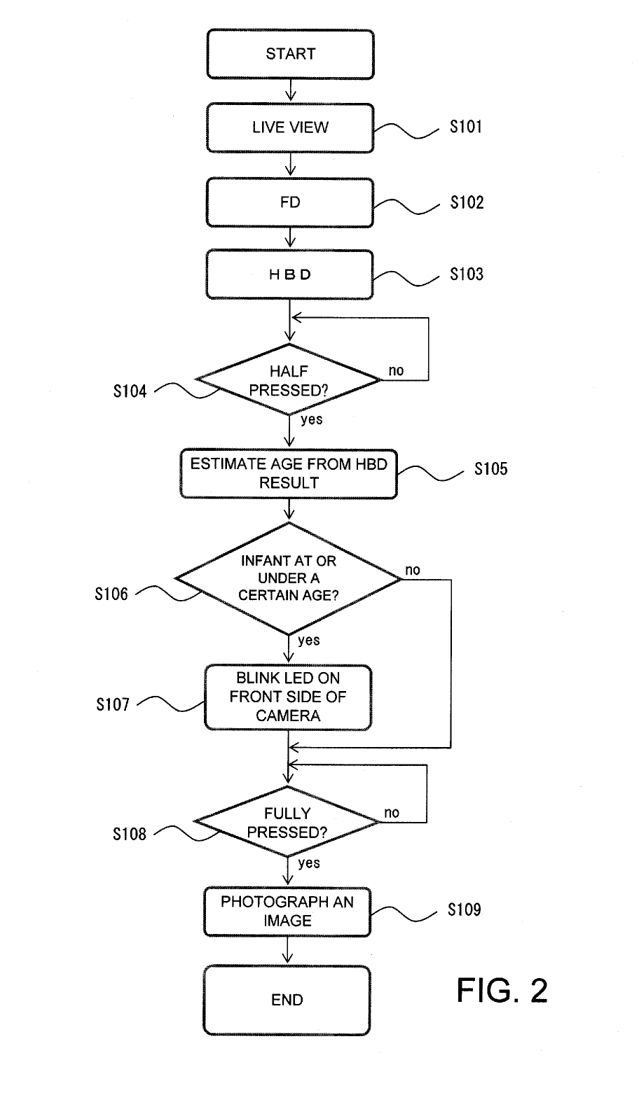

FIG. 2 shows a processing flowchart according to the present embodiment. First, the digital signal processing circuit 18 displays on the liquid crystal monitor 26 an output image signal from the imaging element 14 (live view in S101). The user adjusts a photographing direction or an angle of view while looking at the live view. The digital signal processing circuit 18 then detects the face portion from the photographed image (FD in S102). Simultaneously with FD or shortly before or after FD, the digital signal processing circuit 18 also detects the human body from the photographed image. The human body detection processing will be referred to as human body detection (HBD) hereinafter. The details of HBD will be further described below. HBD and FD are different processing as HBD is processing mainly for detecting a contour of the upper half of the human body, while FD is processing for detecting the human face. It is naturally possible to improve the efficiency of FD by utilizing the detection result of HBD in FD. In this sense, it is also preferable to perform FD after HBD. The results of FD and HBD are supplied from the digital processing circuit 18 to the system control circuit 20.

Then, the system control circuit 20 determines whether or not the shutter button 19a as one of the switches (SW) 19 is half pressed (S104). If the shutter button 19a is half pressed, the system control circuit 20 performs auto focus control so as to focus on the face portion detected through FD or the human body detected through HBD, while estimating the age of the object from the HBD result (S105) and determining whether or not the estimated age is less than or equal to the threshold age and whether or not the object is an infant (S106). Estimation of the age of the object is performed based on the image size of the human body detected through HBD, for example, by calculating a ratio between the length of the head portion and the length of the shoulder portion of the human body, accessing a memory in which a table defining the correspondence relation between this ratio and the age is stored, and reading the age corresponding to the calculated ratio. In the table defining the correspondence relation between the ratio and the age, the ages are segmented into, for example, 0 to 3 years old, 3 to 6 years old, 6 to 9 years old, 9 to 12 years old, 12 to 15 years old, 15 to 18 years old, 18 to 21 years old, and over 22 years old, and the average ratio is determined for each of the segments.

It is also possible to set a threshold age for determining whether or not the object is an infant to be, for example, 3 years old.

If the object is determined to be an infant less than or equal to the threshold age according to the estimated age, the system control circuit 20 causes an LED 30 provided on the front side of the digital camera to blink at predetermined intervals (S107). When the LED on the front side of the digital camera is caused to blink, an infant as the object is expected to pay attention to the blinking LED and look at the digital camera. The user fully presses the shutter button when the infant looks at the digital camera.

The system control circuit 20 determines whether or not the shutter button 19a is fully pressed (S108). If the shutter button 19 is fully pressed, the system control circuit 20 photographs an image of the object (S109), performs processing on the photographed image, and stores the result in the memory card 24.

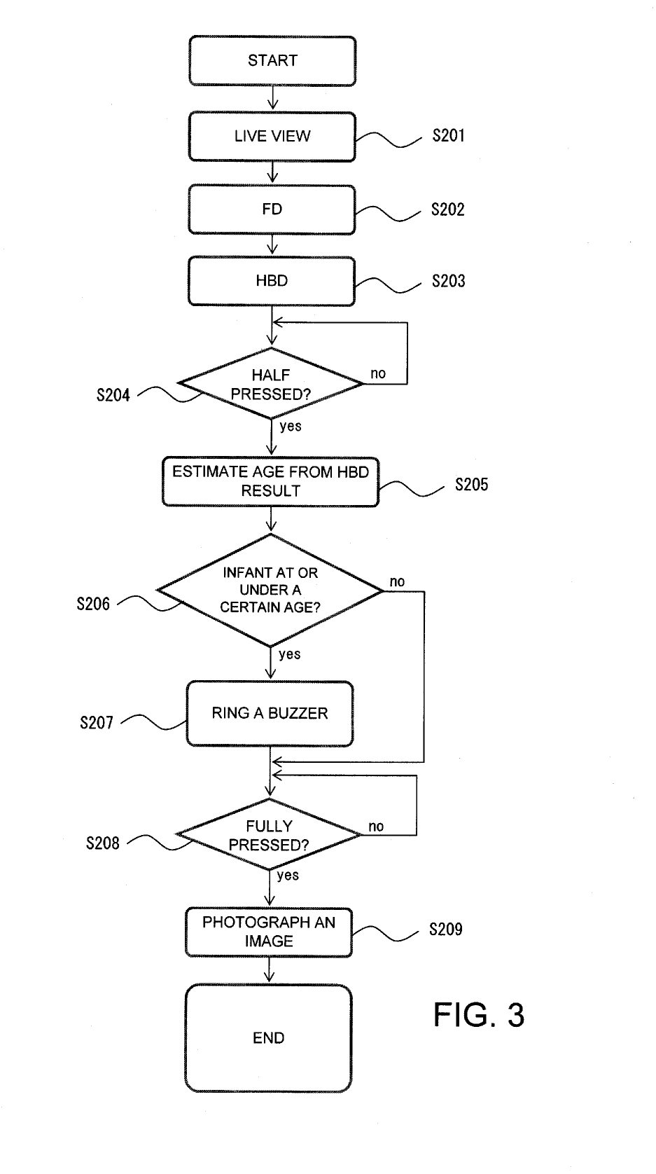

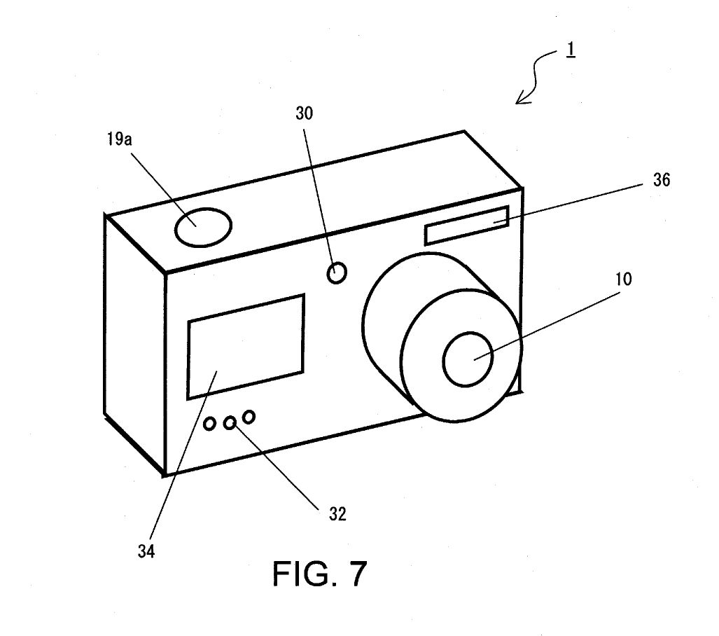

FIG. 3 shows another processing flowchart according to the present embodiment. The difference from FIG. 2 is ringing a buzzer 32 provided on the digital camera (FIG. 7) instead of causing the LED 30 to blink, if the object is determined to be an infant (S207). When the buzzer 32 is rung, an infant is expected to pay attention to the direction from which the sound is coming, and look at the digital camera. The user fully presses the shutter button when the infant looks at the digital camera.

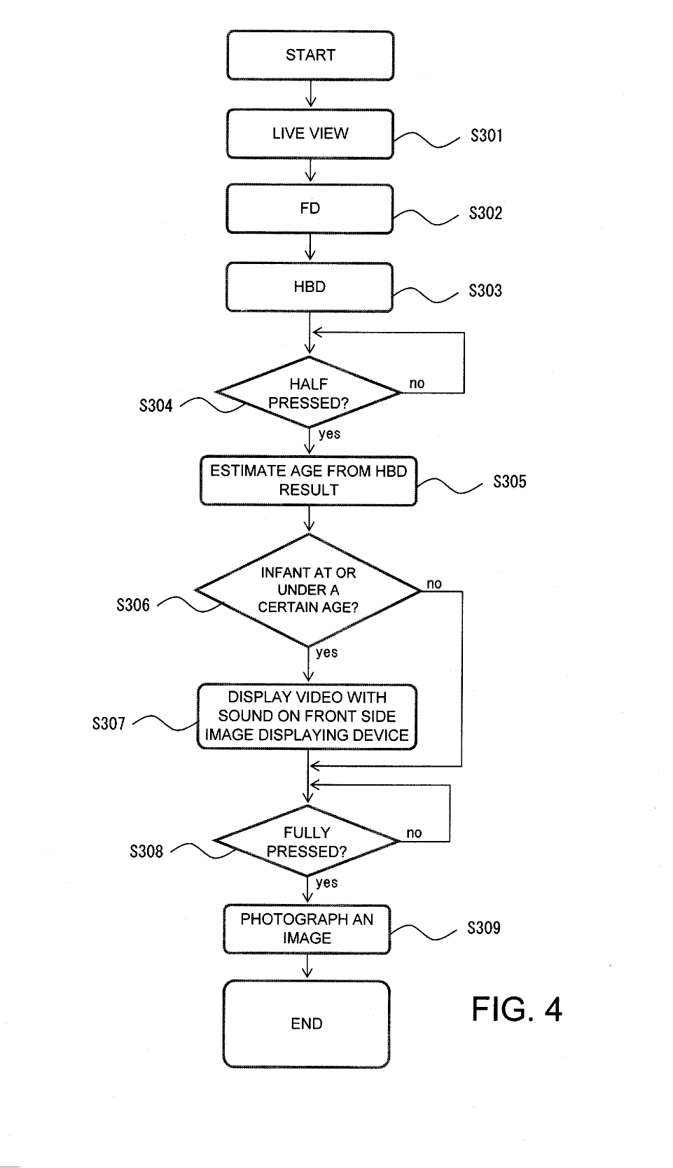

FIG. 4 shows still another processing flowchart according to the present embodiment. The difference from FIG. 2 is displaying a video with sound on an image display device 34 provided on the front side of the digital camera (FIG. 7) if the object is determined to be an infant (S307). The video with sound may be stored in a built-in memory of the system control circuit 20 in advance. The video stored in the memory card 24 may also be read out and displayed. When a video with sound is displayed, an infant is expected to pay attention to this video and look at the digital camera. The user fully presses the shutter button when the infant looks at the digital camera.

Although, in the processing flowcharts in FIG. 2 to FIG. 4, the age of the object is estimated based on the HBD result, the system control circuit 20 may also estimate the age of the object based on the FD result. Specifically, the age is estimated by comparing the amount of characteristic extracted from the contour and the face part area surrounding the eyes and the mouth of the detected face portion, with the amount of characteristic obtained in advance from a plurality of face images for each age. In addition to this, known algorithms can also be used.

In addition, if the age of the object is estimated from the FD result and simultaneously from the HBD result, and if the both estimated ages match within an acceptable range, the age estimated through FD can be evaluated as being highly reliable.

Further, if the age of the object is estimated from the FD result and simultaneously from the HBD result, and if both estimated ages do not match within an acceptable range, whether or not the object is an infant may be determined by comparing the younger estimated age with the threshold age.

Further, if an attempt is made to estimate the age of the object from the FD result and simultaneously from the HBD result, and if, however, age estimation through FD cannot be performed because, for example, the object looks to the side, and the age is therefore estimated by the HBD result alone, the age estimated based on HBD may be compared with the threshold age.

Moreover, it is also possible to evaluate the accuracy of the estimated age in the processing in FIG. 2 to FIG. 4 and change modes of drawing attention according to the accuracy. For example, if the estimation accuracy is evaluated to be relatively low, the modes of ringing a buzzer and displaying a video are not adopted in order to avoid an uncomfortable feeling which may be caused if the object is not actually an infant. Instead, it is preferable to adopt the mode of causing the LED to blink, like when an image is photographed by a self-timer. Age estimation through FD is generally considered to be more accurate than age estimation through HBD. Therefore, if the object is determined to be an infant as a result of age estimation through FD, a video may be displayed, while if the object is determined to be an infant as a result of age estimation through HBD, the LED 30 may be caused to blink.

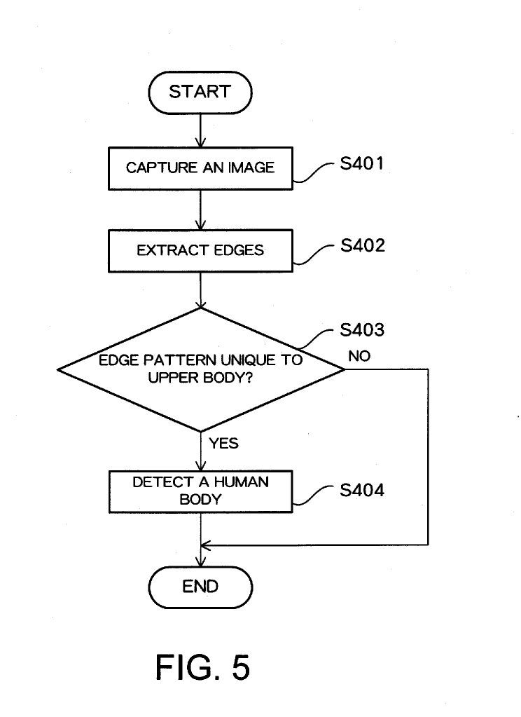

FIG. 5 shows a processing flowchart of human body detection. First, the digital signal processing circuit 18 captures a live view image (S401). The digital signal processing circuit 18 then extracts an edge from the captured image (S402). This edge extraction processing may be carried out by directly employing the contour extraction result obtained in the contour correction processing, or may be carried out by extracting an edge separately from this contour extraction result.

After extracting the edge, the digital signal processing circuit 18 determines whether or not a pattern of the extracted edge matches a predetermined edge pattern of the upper body of a person (S403).

The edge pattern of the upper body is stored as a template in the memory of the digital signal processing circuit 18 in advance. Then, if the extracted edge pattern matches the edge pattern of the upper body, the digital signal processing circuit 18 detects a human body from the extracted edge (S404).

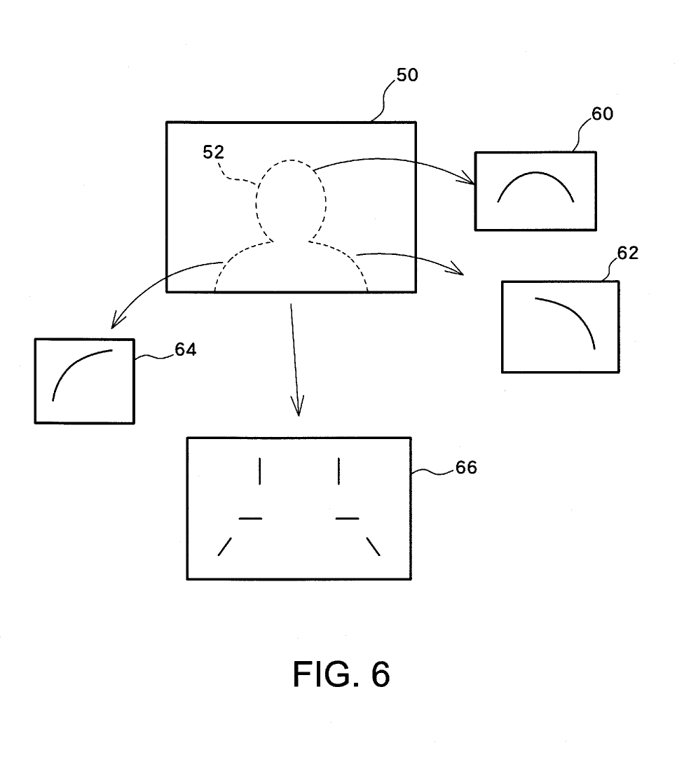

FIG. 6 schematically shows processing of detecting a human body from a photographed image 50. A human body 52 appears in the live view image 50. An arc edge 60 exists in the head portion of the human body. In addition, curve edges 62 and 64 exist in the shoulder portion of the human body. These edges 60, 62, and 64 are stored as templates in the memory, and it is determined whether or not there are patterns matching these templates 60, 62, and 64 in the edges extracted from the photographed image. Naturally, a pattern having a similar shape to a template can be considered to match the template because the size of the human body 52 in the photographed image 50 varies. Naturally, a plurality of templates having different sizes may also be prepared in advance. As such, when the edges of both of the face portion and the shoulder portion are detected, it is possible to detect a human body from the object. A combination 66 of edges on the straight lines of the head portion and edges on the straight lines of the shoulder portion may also be prepared as a template.

As described above, according to the present embodiment, because the age of the object is estimated from information obtained from human body detection (HBD) or face detection (FD), or both of them, and because visual or auditory information attracting the object's attention is provided when the object is determined to be an infant based on the estimated age, it is possible to easily obtain a high quality image in which an infant is looking at the camera.

FIG. 7 shows an example of an external perspective view of a digital camera 1 according to the present embodiment. The digital camera 1 has the lens 10 and the shutter button 19a, and further on the front side, the LED 30, the buzzer 32, the image display device 34, and a flash lamp 36. If the object is determined to be an infant based on the estimated age, the LED 30 provided on the front side of the digital camera 1 is made to blink, the buzzer 32 is rung, or an image is displayed on the image display device 34. When the object is determined to be an infant, flashing the flash lamp 36 may also be preferable. However, upon flashing the flash lamp 36, it is desirable to cause the flash lamp 36 to flash at a weaker intensity than usual in consideration of exposure. One of the LED 31 and the flash lamp 36 may be flashed. Alternatively, both of the LED 30 and the flash lamp 36 may be flashed simultaneously. It may also be possible to cause the LED 30 to flash first and then the flash lamp 36, to thereby attract the attention of the infant more strongly.

Although the present embodiments have been described in relation to a digital camera, the present embodiment can also be applied to a video camera.

What is claimed is:

1. A imaging device comprising:
an optical system comprising a lens;
an imaging section which converts an object image formed by the optical system to an electrical signal; and
a controlling section which estimates an age of an object based on at least one of a human body detected using an edge pattern of an image signal obtained by the imaging section and a face portion detected from the image signal obtained by the imaging section, determines whether or not the object is an infant from the estimated age, and if the object is determined to be an infant, automatically outputs visual or auditory information to the object.

2. The imaging device according to claim 1, wherein
the controlling section estimates the age using a ratio between a length of a head portion and a length of a shoulder portion of the human body.

3. The imaging device according to one of claims 1, wherein
the controlling section estimates ages from both the human body and the face portion, and if the estimated ages match within a predetermined acceptable range, determines whether or not the object is an infant using the estimated age.

4. The imaging device according to claim 1, wherein
the controlling section changes a form of an output between the visual information and the auditory information according to the accuracy of the estimated age.

5. The imaging device according to claim 1, wherein
if the controlling section determines the object to be an infant, the controlling section causes light to blink.

6. The imaging device according to claim 1, wherein
if the controlling section determines the object to be an infant, the controlling section outputs sound.

7. The imaging device according to claim 1, wherein
if the controlling section determines the object to be an infant, the controlling section displays a video.
